(19) United States
(12) Patent Application Publication
(10) Pub. No.: US 2012/0038854 A1
(43) Pub. Date: Feb. 16, 2012

(54) DISPLAY APPARATUS AND LIGHT BARRIER DEVICE

(75) Inventor: Yuichi Inoue, Kanagawa (JP)

(73) Assignee: Sony Corporation, Tokyo (JP)

(21) Appl. No.: 13/197,127

(22) Filed: Aug. 3, 2011

(30) Foreign Application Priority Data
Aug. 10, 2010 (JP) 2010-179556

(51) Int. Cl. G02F 1/1335

(52) U.S. Cl. 349/96; 349/193

(57) ABSTRACT

A display apparatus includes: a display unit having a pair of polarizing plates at a light incident side and a light exit side; and a light barrier unit that is provided at the light incident side or the light exit side of the display unit and includes plural opening and closing parts as light transmission regions or light blocking regions, wherein the light barrier unit has a liquid crystal layer orientation-controlled at a light incident side and a light exit side thereof in directions orthogonal to each other, and an orientation direction at the display unit side of the liquid crystal layer is in parallel or orthogonal to an absorption axis direction of a first polarizing plate of the pair of polarizing plates provided at the light barrier unit side of the display unit.

### FIELD

The present disclosure relates to a display apparatus that can perform stereoscopic view display and a light barrier device used for the display apparatus.

### BACKGROUND

Recently, display apparatuses that can realize stereoscopic view display (stereoscopic display apparatuses) have attracted attention. The stereoscopic vies display is display of videos for left eye and videos for right eye having parallax differences from each other (at different viewpoints), and an observer can recognize them as stereoscopic videos with depths by viewing the respective videos with right and left eyes. Further, display apparatuses that can provide more natural stereoscopic videos for the observer by displaying three or more videos having parallax differences from one another have been developed.

The stereoscopic display apparatuses are roughly divided into apparatuses with and without necessity of dedicated eyeglasses, and the dedicated eyeglasses are annoying for the observer and apparatuses without necessity of dedicated eyeglasses are desired. As the apparatuses without necessity of dedicated eyeglasses, for example, there are apparatuses of lenticular lens system, parallax barrier system, etc.

Of them, in the apparatuses of parallax barrier system, for example, the above described videos for left eye and videos for right eye are displayed in a spatial division manner using a liquid crystal display (LCD), for example, and a predetermined barrier is provided on the display surface. In related art, as the liquid crystal display, various displays have been developed as disclosed in Patent Documents 1 to 3 (JP-A-2-125224, JP-A-6-342154, and JP-A-2002-107712), for example, and recently, displays of VA (Vertical Alignment) mode, IPS (In Plane Switching) mode, and TN (Twisted Nematic) mode, etc. have been often used.

### SUMMARY

On the other hand, also the barrier is often formed using liquid crystal (for example, TN-mode liquid crystal). For example, the liquid crystal has a property that molecules rotate in response to an applied voltage, the refractive index of the part changes, and light modulation is produced. Using the property, transmission and blocking of light are controlled with respect to each predetermined region. Thereby, for example, light transmission parts (slits) and light blocking parts extending along the vertical direction are alternately arranged, for example. The observer may respectively recognize the videos for left eye with the left eye and the videos for right eye with the right eye by observing displayed videos via the barrier, and stereoscopic view is realized.

In the above described barrier using the liquid crystal, the liquid crystal is sealed between a pair of substrates and polarizing plates are bonded to the light incident side and the light exit side, respectively. Here, for example, in the

TN-mode liquid crystal (hereinafter, referred to as “TN liquid crystal”), an orientation direction near the interface with the substrate at the light incident side and an orientation direction near the interface with the substrate at the light exit side are orthogonal to each other, and the respective orientation directions are directions rotated to a predetermined angle (e.g., 135°) from the horizontal direction. Therefore, the transmission axes (or absorption axes) of the polarizing plates provided at the light incident side and the light exit side are aligned with the two orientation directions, respectively (by the two polarizing plates, the respective polarization directions of the incident light to the liquid crystal and the output light from the liquid crystal are controlled in predetermined directions). That is, the absorption axis of the polarizing plate at the light incident side is arranged in a direction rotated to a predetermined angle from the horizontal direction (or the vertical direction).

On the other hand, in the case where the VA-mode liquid crystal (hereinafter, referred to as “VA liquid crystal”) is used in the liquid crystal display, the polarization direction of the display light output from the liquid crystal display is equal to the vertical direction (or the horizontal direction). That is, also, in the liquid crystal display, the polarizing plates are respectively provided at the light incident side and the light exits side and the respective polarization directions of the incident light to and the output light from the liquid crystal are controlled. However, in the VA mode, the absorption axis of the polarizing plate at the light exit side is arranged in the vertical direction (or the horizontal direction).

Therefore, in the case where the liquid crystal display using the VA liquid crystal is combined with the barrier using the TN liquid crystal and the above described stereoscopic display is performed, it is necessary to rotate the polarization direction of the display light output from the liquid crystal display in response to the absorption axis of the polarizing plate at the light incident side of the barrier. For example, a λ/2 plate may be provided between the liquid crystal display and the barrier, or otherwise.

However, if the λ/2 plate is provided between the liquid crystal display and the barrier, there is a problem that the number of parts increases and the cost rises.

Thus, it is desirable to provide a display apparatus and a light barrier device that can realize stereoscopic view display in which reduction of light transmittance can be suppressed without increasing the number of parts and the cost.

A display apparatus according to an embodiment of the present disclosure includes a display unit having a pair of polarizing plates at a light incident side and the light exit side, and a light barrier unit that is provided at a light incident side or the light exit side of the display unit and includes plural opening and closing parts as light transmission regions or light blocking regions. The light barrier unit has a liquid crystal layer orientation-controlled at a light incident side and a light exit side thereof in directions orthogonal to each other. An orientation direction at the display unit side of the liquid crystal layer is in parallel or orthogonal to an absorption axis direction of a first polarizing plate of the pair of polarizing plates provided at the light barrier unit side of the display unit.

A light barrier device according to an embodiment of the present disclosure includes plural opening and closing parts as light transmission regions or light blocking regions, and a liquid crystal layer orientation-controlled in a horizontal direction at one of a light incident side and a light exit side thereof and in a vertical direction at the other.

In the display apparatus according to the embodiment of the present disclosure, predetermined videos displayed by the display unit are transmitted or blocked in the opening and closing parts by the light barrier unit, and thereby, the videos are separated and stereoscopic view display can be performed. Here, in the light barrier unit, the liquid crystal layer is orientation-controlled at the light incident side and the light exit side in directions orthogonal to each other, and the orientation direction at the display unit side of the liquid crystal layer is in parallel or orthogonal to the absorption axis direction of the first polarizing plate at the light barrier unit side of the display unit. That is, the light output from the display unit enters the liquid crystal layer of the light barrier unit with its polarization direction kept (or the light output from the light barrier unit enters the display unit with its polarization direction kept).

In the light barrier device according to the embodiment of the present disclosure, in the liquid crystal layer, orientation control is performed in the nearly horizontal direction at one of the light incident side and the light exit side thereof and in the nearly vertical direction at the other. Thereby, in the case where the device is used in combination with a display unit having liquid crystal in a VA mode and an IPS mode, for example, the light output from the display unit enters the liquid crystal layer of the light barrier unit with its polarization direction kept (or the light output from the light barrier unit enters the display unit with its polarization direction kept).

According to the display apparatus of the embodiment of the present disclosure, the liquid crystal layer in the light barrier unit is orientation-controlled at the light incident side and the light exit side in directions orthogonal to each other, and the orientation direction at the display unit side of the liquid crystal layer is in parallel or orthogonal to the absorption axis direction of the first polarizing plate at the light barrier unit side of the display unit. Thereby, the light output from the display unit may be allowed to enter the liquid crystal layer of the light barrier unit without rotation of its polarization direction (polarization axis) (or the light output from the light barrier unit may be allowed to enter the display unit without rotation of its polarization direction). That is, it is not necessary to separately provide an optical member for rotation of the polarization direction, e.g., a λ/2 plate or the like between the display unit and the light barrier unit. Thus, stereoscopic view display of parallax barrier system using a liquid crystal barrier can be realized without increase in the number of parts and the cost.

Further, thereby, it is only necessary to provide the first polarizing plate between the display unit and the light barrier unit, and the light transmittance may be improved compared to the case where two polarizing plates are inserted between them.

### BRIEF DESCRIPTION OF THE DRAWINGS

FIG. 1 is a block diagram showing one configuration example of a stereoscopic display apparatus according to an embodiment of the present disclosure.

FIGS. 2A and 2B are explanatory diagrams showing the one configuration example of the stereoscopic display apparatus shown in FIG. 1.

FIG. 3 is an explanatory diagram showing one configuration example of a display unit shown in FIG. 1.

FIGS. 4A and 4B are explanatory diagrams showing one configuration example of a pixel circuit shown in FIG. 3.

FIGS. 5A and 5B are explanatory diagrams showing one configuration example of a liquid crystal barrier shown in FIG. 1.

FIGS. 6A and 6B are explanatory diagrams showing one operation example of the liquid crystal barrier shown in FIG. 1.

FIG. 7 is an explanatory diagram showing one configuration example near a liquid crystal layer shown in FIGS. 5A and 5B.

FIG. 8 is a sectional view showing detailed configurations of a WV film and a polarizing plate at an exit side shown in FIGS. 5A and 5B.

FIGS. 9A and 9B are schematic diagrams for explanation of orientation states of the WV film and a TN liquid crystal layer shown in FIGS. 5A and 5B.

FIG. 10 is a schematic diagram for explanation of polarization axes and liquid crystal orientation control directions.

FIGS. 11A and 11B are schematic diagrams for explanation of relationships between modes of liquid crystal molecules and absorption axes.

FIG. 12 is a schematic diagram showing one operation example of stereoscopic view display of the liquid crystal barrier according to the embodiment.

FIGS. 13A to 13C are schematic diagrams showing one operation example of the display unit and the liquid crystal barrier according to the embodiment.

FIGS. 14A and 14B are another schematic diagrams showing one operation example of the display unit and the liquid crystal barrier according to the embodiment.

FIG. 15 is a schematic diagram for explanation of polarization axes and liquid crystal orientation control directions of a stereoscopic display apparatus according to a comparative example.

FIGS. 16A and 16B are characteristics charts showing ranges of viewing angles at black representation in the comparative example and the embodiment.

FIG. 17 is a schematic diagram for explanation of polarization axes and liquid crystal orientation control directions of a stereoscopic display apparatus according to modified example 1.

FIG. 18 is a schematic diagram for explanation of polarization axes and liquid crystal orientation control directions of a stereoscopic display apparatus according to modified example 2.

### DETAILED DESCRIPTION

As below, embodiments of the present disclosure will be explained in detail with reference to the drawings. The explanation will be made in the following order.

1. Embodiment (Example of liquid crystal barrier corresponding to display unit in VA, IPS modes)

2. Modified Example 1 (Another example of liquid crystal barrier corresponding to display unit in VA, IPS modes)

3. Modified Example 2 (Example of liquid crystal barrier corresponding to display unit in TN mode)

### [Overall Configuration]

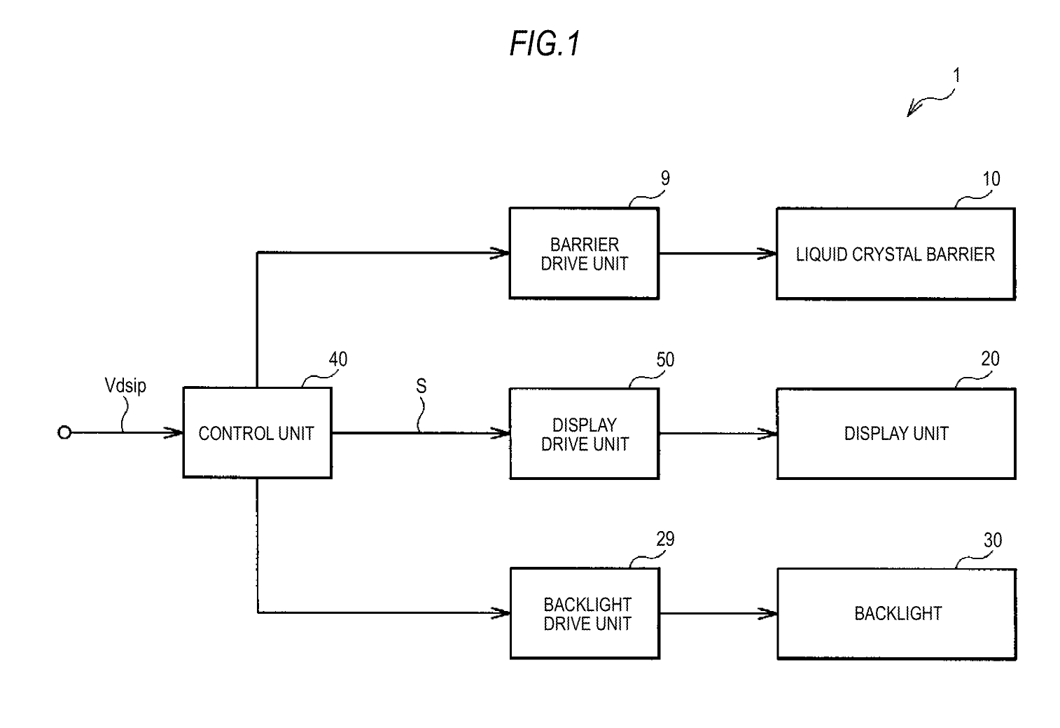

FIG. 1 shows one configuration example of a stereoscopic display apparatus (stereoscopic display apparatus 1) according to an embodiment of the present disclosure. Here, the stereoscopic display apparatus 1 is a display apparatus that can realize both stereoscopic view display and normal display (two-dimensional display). The stereoscopic display apparatus 1 includes a control unit 40, a display drive unit 50, a display unit 20, a backlight drive unit 29, a backlight 30, a barrier drive unit 9, and a liquid crystal barrier 10 (light barrier unit, light barrier device).

The control unit 40 is a circuit that respectively supplies control signals to the display drive unit 50, the backlight drive unit 29, and the barrier drive unit 9 based on externally supplied video signals Vdisp, and controls the units to operate in synchronization with one another. Specifically, the control unit 40 is adapted to supply a video signal S based on the video signal Vdisp to the display drive unit 50, supplies a backlight control command to the backlight drive unit 29, and supplies a barrier control command to the barrier drive unit 9. Here, the video signal S includes video signals SA, SB respectively containing plural viewpoint videos (six in this example) in the case where the stereoscopic display apparatus 1 performs stereoscopic view display, as will be described later.

The display drive unit 50 drives the display unit 20 according to the video signal S supplied from the control unit 40. The display unit 20 performs display by driving a liquid crystal device and modulating light output from the backlight 30.

The backlight drive unit 29 drives the backlight 30 based on the backlight control signal supplied from the control unit 40. The backlight 30 has a function of outputting surface-emitted light to the display unit 20.

The barrier drive unit 9 drives the liquid crystal barrier 10 according to the barrier control command supplied from the control unit 40. The liquid crystal barrier 10 has plural opening and closing parts 11, 12 including liquid crystal, which will be described later, and has a function of transmitting or blocking the light output from the backlight 30 and transmitted through the display unit 20.

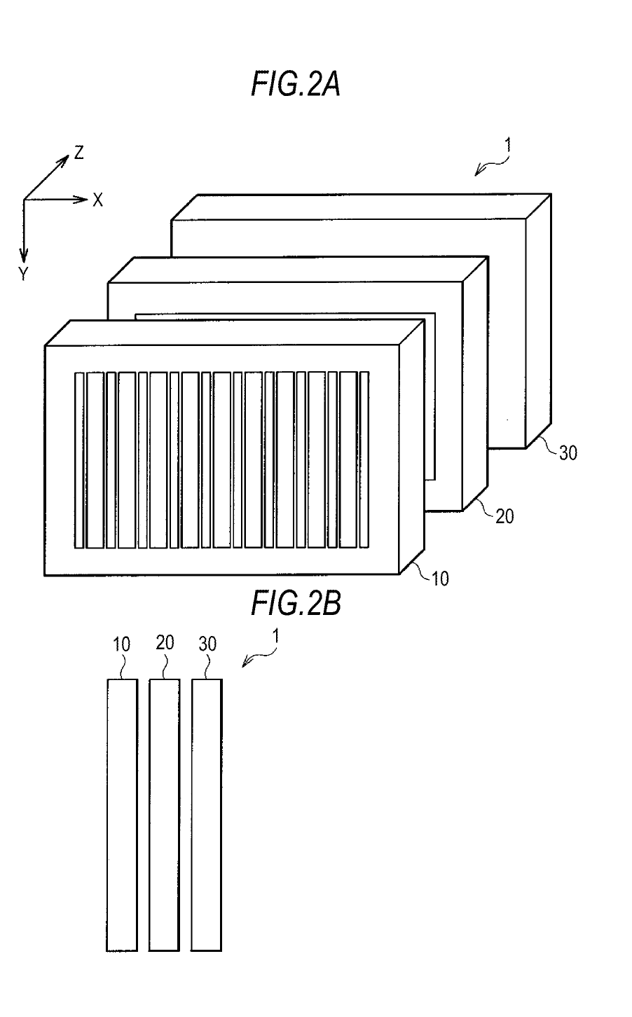

FIGS. 2A and 2B show one configuration example of a main part of the stereoscopic display apparatus 1, and FIG. 2A shows a configuration of the stereoscopic display apparatus 1 in a perspective view and FIG. 2B shows the configuration of the stereoscopic display apparatus 1 in a side view. As shown in FIGS. 2A and 2B, in the stereoscopic display apparatus 1, from the backlight 30 side, the display unit 20 and the liquid crystal barrier 10 are sequentially arranged. That is, the light output from the backlight 30 reaches an observer via the display unit 20 and the liquid crystal barrier 10. In the embodiment, though their details will be described later, the display unit 20 and the liquid crystal barrier 10 are bonded. It is desirable that they are bonded, however, they may not necessarily be bonded.

### (Display Drive Unit 50 and Display Unit 20)

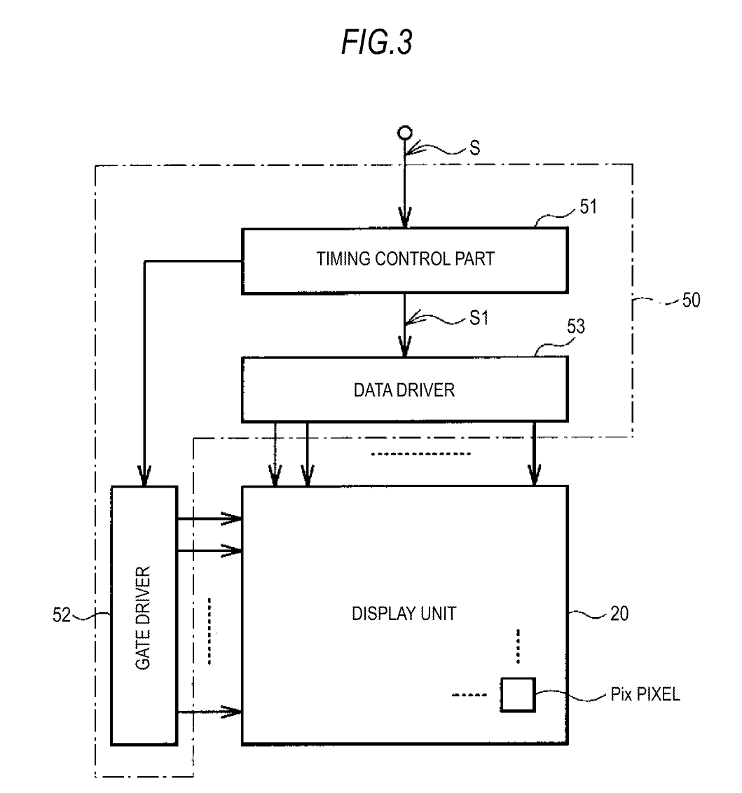

FIG. 3 shows an example of a block diagram of the display drive unit 50 and the display unit 20. Pixels Pix are arranged in a matrix in the display unit 20. The display drive unit 50 includes a timing control part 51, a gate driver 52, and a data driver 53. The timing control part 51 controls drive timing of the gate driver 52 and the data driver 53, and supplies the video signal S supplied from the control unit 40 to the data driver 53 as a video signal S1. The gate driver 52 performs line-sequential scanning by sequentially selecting the pixels Pix within a liquid crystal display device 45, which will be described later, with respect to each row according to the timing control by the timing control part 51. The data driver 53 supplies pixel signals based on the video signal 51 to the respective pixels Pix of the display unit 20. Specifically, the data driver 53 is adapted to perform D/A (digital/analog) conversion based on the video signal 51, and thereby, generate pixel signals as analog signals and supply them to the respective pixels Pix.

The display unit 20 is formed by sealing a liquid crystal material between two transparent substrates of glass or the like, for example. In parts of the transparent substrates facing the liquid crystal material, transparent electrodes including ITO (Indium Tin Oxide) or the like, for example, are formed and form the pixels Pix together with the liquid crystal material. As the liquid crystal material in the display unit 20, for example, liquid crystal of VA mode, IPS mode, TN mode, or the like using nematic liquid crystal is used. In the embodiment, the case of using the VA-mode or IPS-mode liquid crystal of them will be explained. As below, the configuration of the display unit 20 (pixel Pix) will be explained in detail.

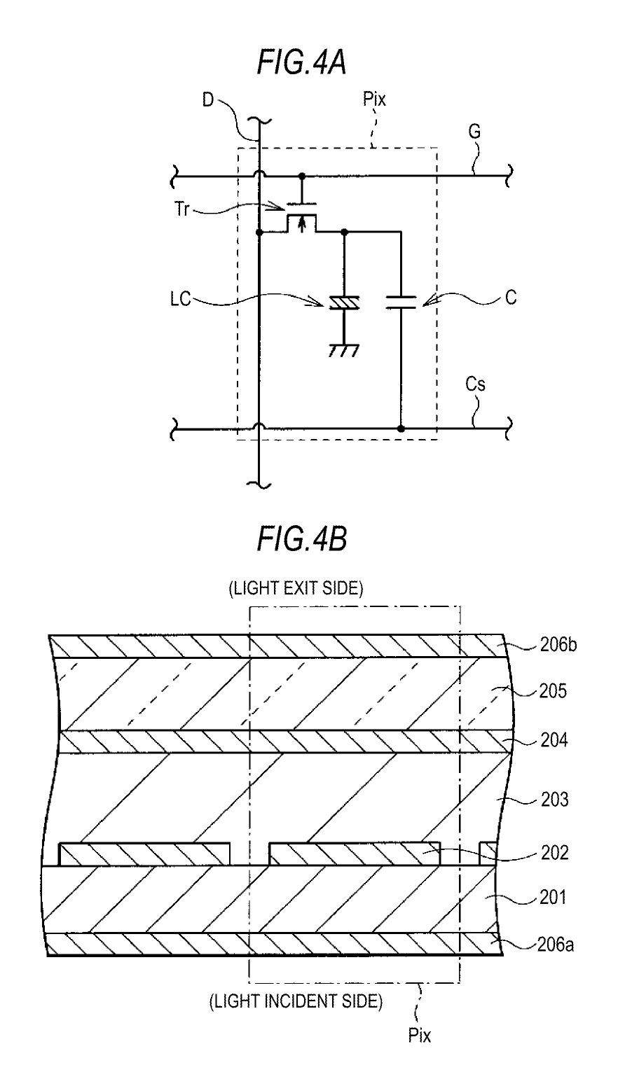

FIG. 4A shows an example of a circuit diagram of the pixel Pix. The pixel Pix includes a TFT (Thin Film Transistor) device Tr, a liquid crystal device LC, and a retention volume device C. The TFT device Tr includes a MOS-FET (Metal Oxide Semiconductor-Field Effect Transistor), for example, and has a gate connected to a gate line G, a source connected to a data line D, and a drain connected to one end of the liquid crystal device LC and one end of the retention volume device C. The liquid crystal device LC has one end connected to the drain of the TFT device Tr and the other end connected to the ground. The retention volume device C has one end connected to the drain of the TFT device Tr and the other end connected to a retention volume line Cs. The gate line G is connected to the gate driver 52 and the data line D is connected to the data driver 53.

FIG. 4B shows a sectional configuration of the display unit 20 containing the pixel Pix. As seen in the section, the display unit 20 is formed by sealing a liquid crystal layer 203 between a drive substrate 201 and an opposed substrate 205. In the drive substrate 201, a pixel drive circuit containing the TFT device Tr is formed, and a pixel electrode 202 is provided on the drive substrate 201 with respect to each pixel Pix. In the opposed substrate 205, a color filter and a black matrix (not shown) are formed, and an opposed electrode 204 is further provided on the surface at the liquid crystal layer 203 side as a common electrode among the respective pixels Pix.

To the light incident side (backlight 30 side) of the display unit 20, a polarizing plate 206a is bonded to control the polarization direction of incident light to the liquid crystal layer 203. On the other hand, a polarizing plate 206b is also bonded to the light exit side of the display unit 20 in crossed nicols or parallel nicols with the polarizing plate 206a. In the embodiment, the respective absorption axes of the polarizing plate 206b (first polarizing plate) at the light exit side (at the liquid crystal barrier 10 side in this example) in the display unit 20 and the polarizing plate (second polarizing plate) at the light incident side (at the display unit 20 side in this example) in the liquid crystal barrier 10, which will be described later, are aligned with each other. Here, the polarizing plate 206b also serves as an incident-side polarizing plate of the liquid crystal barrier 10. That is, the liquid crystal barrier 10 (in detail, a WV film 17b, which will be described later) is directly bonded onto the polarizing plate 206b. Note that, in the specifications, “aligned” is not limited to that the axis directions are completely the same, but contains that they are generally the same.

### (Backlight 30)

The backlight 30 is formed by providing LEDs (Light Emitting Diodes), for example, on a side surface of a light guide plate, for example. Alternatively, the backlight 30 may be formed by arranging plural CCFLs (Cold Cathode Fluorescent Lamps) or the like.

### (Liquid Crystal Barrier 10)

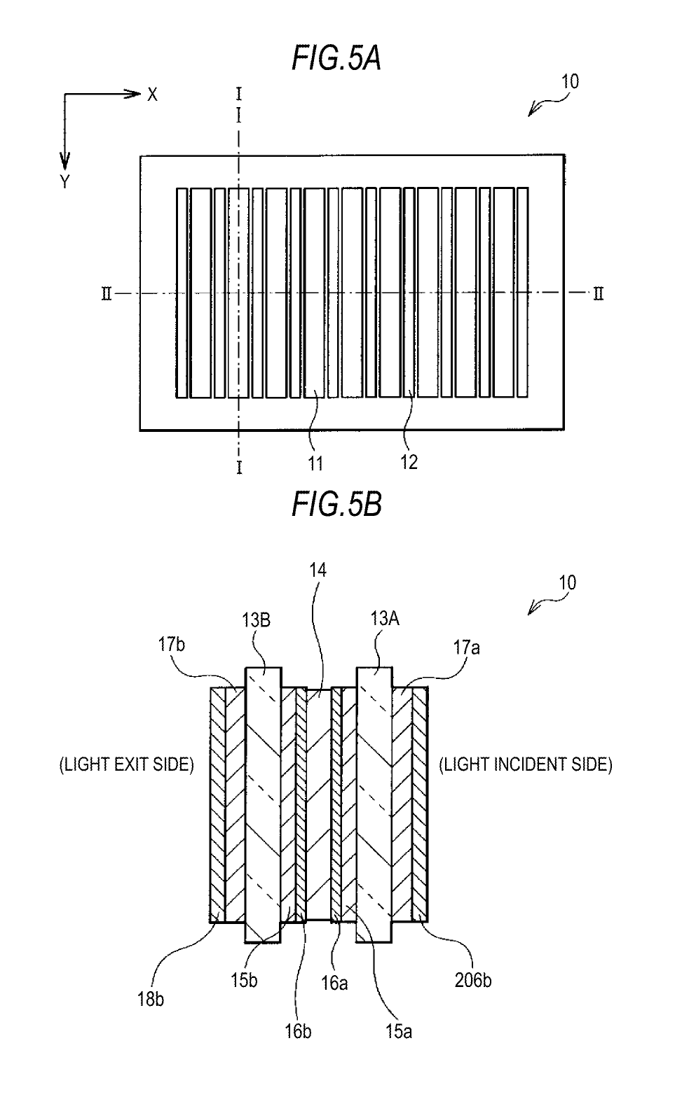

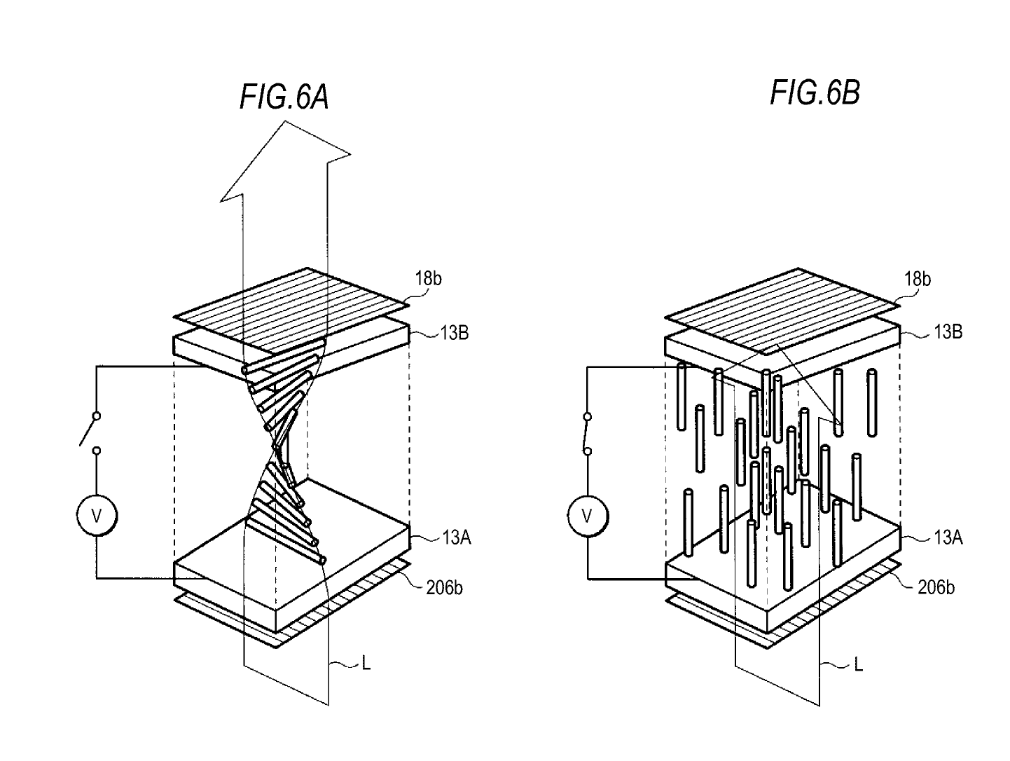

FIGS. 5A and 5B show one configuration example of the liquid crystal barrier 10, and FIG. 5A shows a plan view of the liquid crystal barrier 10 and FIG. 5B shows a sectional view along I-I line. In this example, the case where the liquid crystal barrier 10 performs a normally white operation will be explained. For example, as shown in FIG. 6A, light is transmitted (white representation) in a state in which no drive voltage is applied and light is blocked (black representation) in a state in which a drive voltage is applied.

As shown in FIG. 5A, the liquid crystal barrier 10 has plural opening and closing parts 11, 12 that transmit or block light. The opening and closing parts 11, 12 perform different operations depending on which of normal display (two-dimensional display) and stereoscopic display the stereoscopic display apparatus 1 performs. Specifically, as will be described later, the opening and closing part 11 turns into an opening state (transmission state) at normal display and turns into a closing state (blocking state) at stereoscopic view display. As will be described later, the opening and closing part 12 turns into an opening state (transmission state) at normal display and time-divisionally performs opening and closing operations at stereoscopic view display. The plural opening and closing parts 11, 12 are respectively and alternately provided, and adapted to be driven with respect to each groupincluding selective opening and closing parts of the plural opening and closing parts 11, 12 or time-divisionally driven with respect to each group.

As shown in FIG. 5B, the liquid crystal barrier 10 includes a liquid crystal layer 14 between a transparent substrate 13A and a transparent substrate 13B of glass or the like, for example. Of the transparent substrates 13A, 13B, the transparent substrate 13A is provided at the light incident side and the transparent substrate 13B is provided at the light exit side. On the surface of the transparent substrate 13A at the liquid crystal layer 14 side and the surface of the transparent substrate 13B at the liquid crystal layer 14 side, transparent electrodes 15a, 15b of ITO or the like, for example, are formed, respectively. To the light exit side of the transparent substrate 13B, a WV (Wide View) film 17b and an exit-side polarizing plate 18b are bonded in this order. On the other hand, also, to the light incident side of the transparent substrate 13A, a WV film 17b is bonded. Here, in the embodiment, as described above, the polarizing plate 206b at the exit side in the display unit 20 also serves as a polarizing plate at the light incident side in the liquid crystal barrier 10, and the WV film 17b is directly bonded to the polarizing plate 206b. As below, configurations of the respective parts will be described in detail.

The liquid crystal layer 14 includes TN-mode liquid crystal (TN liquid crystal) using nematic liquid crystal, for example. Here, in a state in which no drive voltage is applied, directors of liquid crystal molecules are orthogonal to each other between the light incident side and the light exit side, and arranged with their directions changed while rotating along the thickness direction of the liquid crystal layer 14 (white representation: FIG. 6A). On the other hand, in a state in which a drive voltage is applied, the directors of liquid crystal molecules are arranged along the thickness direction of the liquid crystal layer 14 (black representation: FIG. 6B).

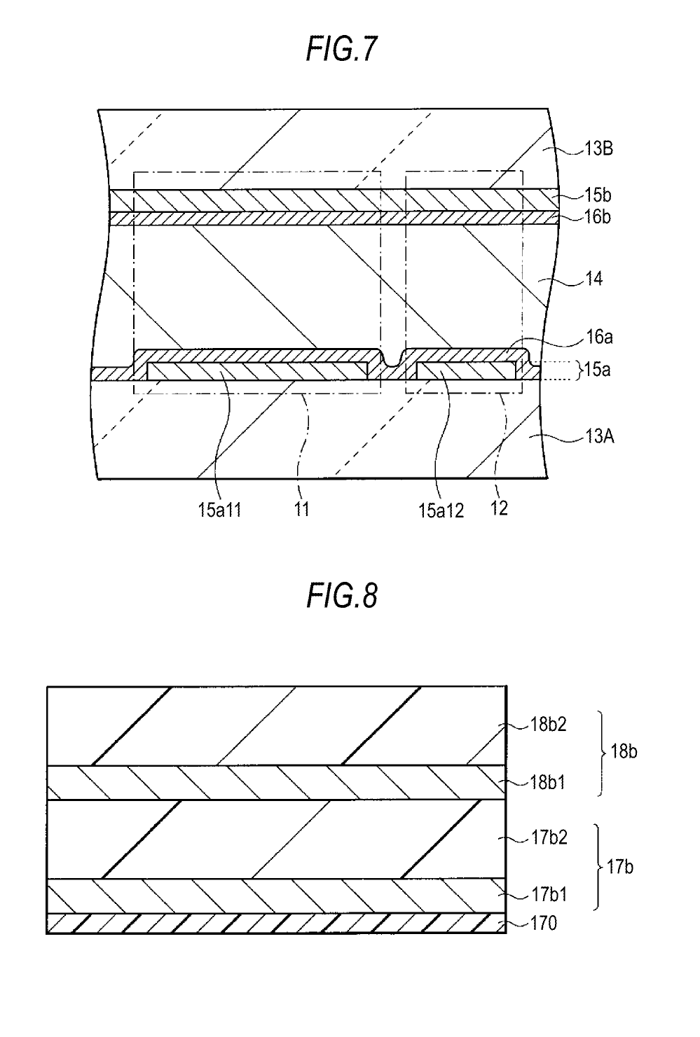

FIG. 7 shows a sectional configuration along II-II line in FIG. 5A. For simplicity, only the component elements near the liquid crystal layer 14 are shown. At least one of the transparent electrodes 15a, 15b is divided into plural sub-electrodes to which voltages can be supplied individually. For example, the transparent electrode 15a is divided into plural sub-electrodes 15a11, 15a12, the transparent electrode 15b is provided as a common electrode between the respective sub-electrodes 15a11, 15a12. The regions respectively corresponding to the sub-electrodes 15a11, 15a12 are the opening and closing parts 11, 12. According to the configuration, voltages are applied only to the selective regions of the liquid crystal layer 14, and transmission (white representation) and blocking (black representation) are switched with respect to each of the opening and closing parts 11, 12. On the transparent electrodes 15a, 15b, orientation films 16a, 16b are further formed.

As the orientation films 16a, 16b, for example, AL3046 (manufactured by JSR: product name) or the like is used, and the films have a function of controlling orientations of the liquid crystal molecules near the interfaces of themselves. The orientation control directions in the orientation films 16a, 16b are formed by rubbing treatment, for example, and set in response to the mode of the liquid crystal used for the liquid crystal layer 14, and the polarization axes of the polarizing plates, which will be described later, for example. Specifically, in the case where the liquid crystal layer 14 has the TN liquid crystal, rubbing treatment is performed so that the respective orientation control directions of the orientation films 16a, 16b may be orthogonal to each other, and the liquid crystal molecules near the interfaces of the respective orientation films maybe oriented along a direction in response to the absorption axes of the polarizing plate 206b and the exit-side polarizing plate 18b, i.e., here, a direction in parallel or orthogonal to the directions of the absorption axes.

The polarizing plate 206b and the exit-side polarizing plate 18b control the respective polarization directions of the incident light to and the output light from the liquid crystal layer 14. In the case of using the TN liquid crystal for the liquid crystal layer 14, the respective absorption axes of the polarizing plate 206b and the exit-side polarizing plate 18b are arranged to be orthogonal to each other.

FIG. 8 shows detailed configurations of the WV film 17b and the exit-side polarizing plate 18b. As shown in the drawing, the WV film 17b and the exit-side polarizing plate 18b are bonded onto the transparent substrate 13A (not shown in FIG. 8) via an adhesive layer 170. The WV film 17b has a function of enlarging the viewing angle, and is a laminated film of a liquid crystal layer 17b1 including discotic liquid crystal and a TAC (triacetylcellulose) 17b2, for example. The exit-side polarizing plate 18b is a laminated film of a PVA polarizer 18b1 and a TAC 18b2. The TAC 17b2, 18b2 function as protective films of the WV film 17b and the exit-side polarizing plate 18b, respectively.

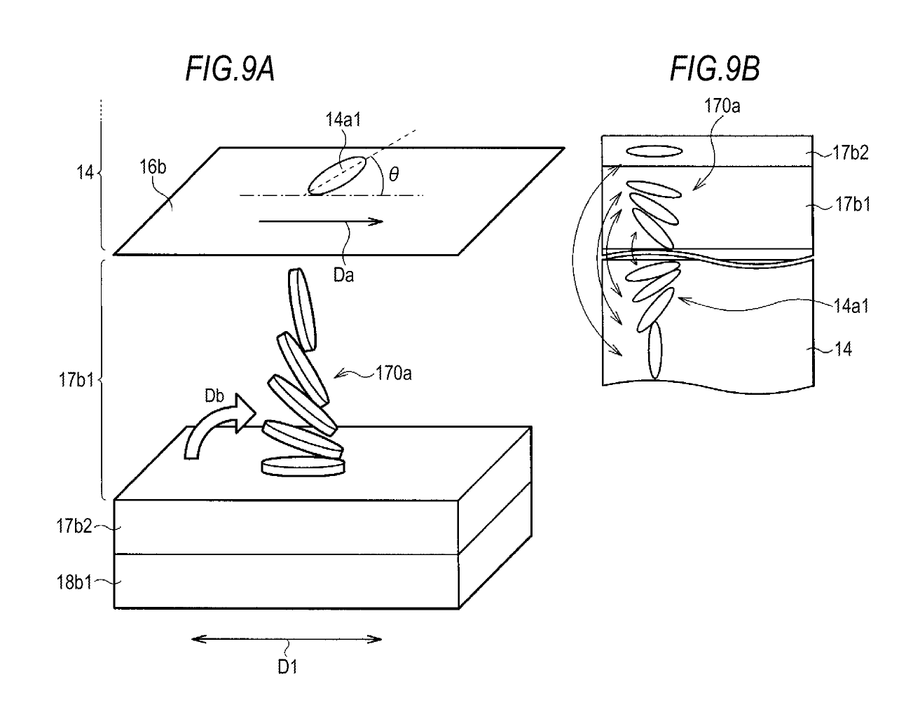

FIGS. 9A and 9B are explanation diagrams of orientation states of the liquid crystal molecules of the WV film 17b and the liquid crystal layer 14. As shown in FIG. 9A, though details will be described later, for example, when liquid crystal molecules 14a1 are in the O mode, rubbing treatment is performed on the orientation film 16a along a direction Da in parallel to the absorption axis D1 of the exit-side polarizing plate 18b. Thereby, orientation is set so that the director may be along the absorption axis D1 and may rise to a predetermined angle (e.g., θ is 3° to 5°) (to which the so-called pre-tilt is added). On the other hand, in the liquid crystal layer 17b1 in the WV film 17b, liquid crystal molecules 170a are oriented so that the rising angle along a rotational direction Db may gradually become larger from the interface with TAC 17b2 toward the liquid crystal layer 14. In detail, for example, it is desirable to set orientation so that the direction of the director of the liquid crystal molecule 14a1 in the liquid crystal layer 14 and the direction of the director of the liquid crystal molecule 170a in the WV film 17b have an arrangement relation shown in FIG. 9B.

(Relationships between Polarization Axes of Polarizing Plates and Liquid Crystal Orientation Control Directions)

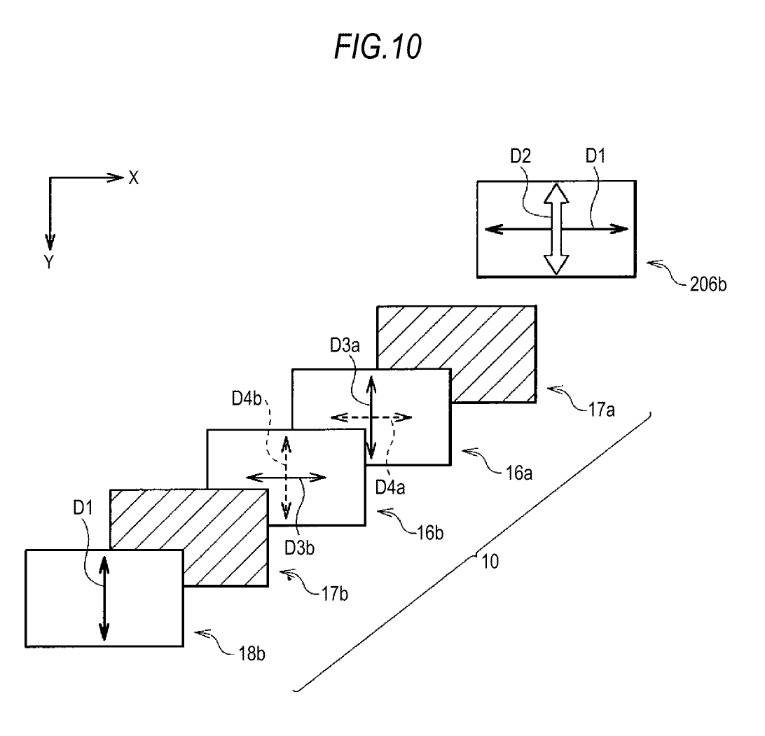

In the embodiment, in the above described configuration, the respective component elements are provided so that the respective polarization directions of the output light from the display unit 20 and the incident light to the liquid crystal layer 14 in the liquid crystal barrier 10 may be aligned with each other. Specifically, there is an arrangement relationship shown in FIG. 10. That is, in the case where the absorption axis D1 of the polarizing plate 206b that serves as both the exit-side polarizing plate in the display unit 20 and the incident-side polarizing plate in the liquid crystal barrier 10 is equal to the horizontal direction X, the respective rubbing directions in the orientation films 16a, 16b are the horizontal direction or the vertical direction. For example, in the orientation films 16a, 16b, the directions are one of a combination of directions D3a, D3b (solid-line arrows) or a combination of directions D4a, D4b (broken-line arrows). One of the combinations may be appropriately set depending on whether the liquid crystal molecules 14a1 in the liquid crystal layer 14 are in the O-mode or the E-mode. In either case, when the TN liquid crystal is used for the liquid crystal layer 14, the absorption axis D1 in the exit-side polarizing plate 18b is aligned with the vertical direction Y.

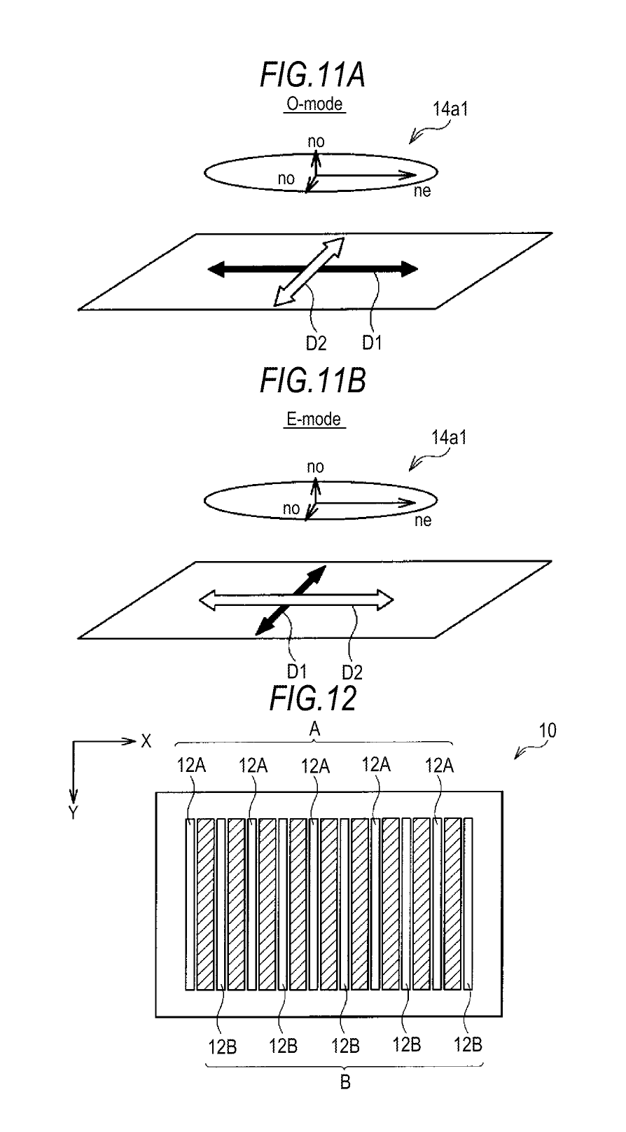

Note that the relationships between the respective orientation control directions (the directions of the directors of the liquid crystal molecules near the orientation film interfaces) in the orientation films 16a, 16b and the absorption axes (transmission axes) of the exit-side polarizing plate 18b and the polarizing plate 206b differ depending on the mode of the liquid crystal molecules (for example, the 0 (normal) mode, E (special) mode). For example, when the liquid crystal molecules are in the O-mode, as shown in FIG. 11A, the incident polarized light to the liquid crystal layer 14 (transmission axis D2) is substantially perpendicular to the director of the liquid crystal molecules. That is, in the case of the O-mode, rubbing treatment is performed so that the absorption axes of the respective polarizing plates and the director of the liquid crystal molecules 14a1 may be the same direction. On the other hand, when the liquid crystal molecules are in the E-mode, as shown in FIG. 11B, the incident polarized light to the liquid crystal layer 14 (transmission axis D2) is substantially along the director of the liquid crystal molecules. That is, in the case of the E-mode, rubbing treatment is performed so that the absorption axes of the respective polarizing plates and the director of the liquid crystal molecules 14a1 may be orthogonal to each other. For example, in the example shown in FIG. 10, the directions may be set to the directions D4a, D4b in the case of the O-mode, and may be set to the directions D3a, D3b in the case of the E-mode.

As described above, in the embodiment, the absorption axes of the polarizing plate 206b and the exit-side polarizing plate 18b are set so that the output polarized light from the display unit 20 and the incident polarized light to the liquid crystal layer 14 of the liquid crystal barrier 10 may be aligned, and the orientation control directions in the liquid crystal layer 14 are set in response thereto.

Note that, in this example, the liquid crystal barrier 10 performs the normally white operation, however, not limited to that, may perform a normally black operation, for example, instead. The selection of the normally black operation and the normally white operation may be set depending on the polarizing plates and the liquid crystal orientations, for example.

The barrier drive unit 9 drives the plural opening and closing parts 11, 12 belonging to the same group to perform opening and closing operations at the same times at stereoscopic view display. Specifically, though details will be described later, the barrier drive unit 9 drives the plural opening and closing parts 12 belonging to group A and the plural opening and closing parts 12 belonging to group B to time-divisionally and alternately perform opening and closing operations.

FIG. 12 shows a group configuration example of the opening and closing parts 12. The opening and closing parts form two groups, for example. Specifically, the alternately arranged plural opening and closing parts 12A form the group A and plural opening and closing parts 12B form the group B, respectively.

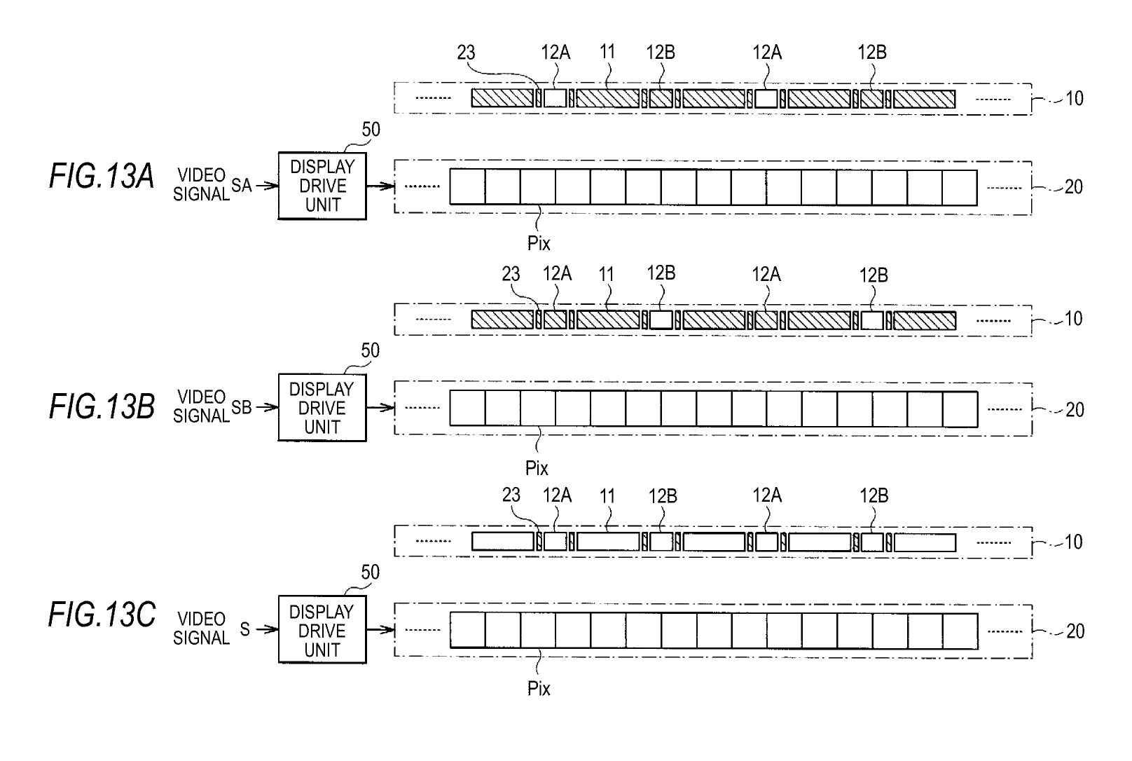

FIGS. 13A to 13C schematically show states of the liquid crystal barrier 10 when stereoscopic view display and normal display (two-dimensional display) are performed, and FIG. 13A shows one state when stereoscopic view display is performed, FIG. 13B shows another state when stereoscopic view display is performed, and FIG. 13C shows a state when normal display is performed. In the liquid crystal barrier 10, the opening and closing parts 11 and the opening and closing parts 12 (the opening and closing parts 12A belonging to the group A and the opening and closing parts 12B belonging to the group B) are alternately arranged. In this example, the opening and closing parts 12A, 12B are respectively provided in a ratio of one to six pixels Pix of the display unit 20. In the following explanation, the pixel Pix is a pixel including three sub-pixels of RGB, however, not limited to that, for example, the pixel Pix may be a sub-pixel. Note that, in the liquid crystal barrier 10, the parts in which light is blocked are shown by shading.

When the stereoscopic view display is performed, video display based on video signals SA, SB is time-divisionally performed in the display unit 20, and the opening and closing parts 12 (opening and closing parts 12A, 12B) are opened and closed in synchronization with the time-division display of the display unit 20 in the liquid crystal barrier 10. In this regard, the opening and closing parts 11 are maintained in the closing state (blocking state). Specifically, though details will be described later, as shown in FIG. 13A, when the video signal SA is supplied, the opening and closing parts 12A turn into the opening state and the opening and closing parts 12B turn into the closing state in the liquid crystal barrier 10. The display unit 20 displays six viewpoint videos contained in the video signal SA on the six pixels Pix adjacent to each other provided in locations corresponding to the opening and closing parts 12A. Similarly, as shown in FIG. 13B, when the video signal SB is supplied, the opening and closing parts 12B turn into the opening state and the opening and closing parts 12A turn into the closing state in the liquid crystal barrier 10. The display unit 20 displays six viewpoint videos contained in the video signal SB on the six pixels Pix adjacent to each other provided in locations corresponding to the opening and closing parts 12B.

On the other hand, when the normal display (two-dimensional display) is performed, as shown in FIG. 13C, display based on the video signal S is performed in the display unit 20, and both the opening and closing parts 11 and the opening and closing parts 12 (opening and closing parts 12A, 12B) are maintained in the opening state (transmission state) in the liquid crystal barrier 10.

Opening and closing part boundaries 23 are provided between the opening and closing parts 11 and the opening and closing parts 12. The opening and closing part boundaries 23 correspond to parts in which one of the transparent electrodes 15a, 15b is not formed on the transparent substrates 13A, 13B. That is, as described above, at least one of the transparent electrodes 15a, 15b is divided into plural sub-electrodes, and the boundaries correspond to the regions between the sub-electrodes. In the opening and closing part boundaries 23, it is hard to apply desired voltages, and the boundaries are constantly in the opening state (transmission state) in the liquid crystal barrier 10 that performs the normally white operation. Note that the opening and closing part boundaries 23 are sufficiently smaller than the opening and closing parts 11, 12, and hardly annoy the observer. In the following drawings and explanation, the opening and closing part boundaries 23 will be appropriately omitted.

### [Operations and Actions]

Subsequently, operations and actions of the stereoscopic display apparatus 1 of the embodiment will be explained.

### (Summary of Overall Operation)

The control unit 40 respectively supplies control signals to the display drive unit 50, the backlight drive unit 29, and the barrier drive unit 9 according to the externally supplied video signal Vdisp, and controls the units to operate in synchronization with one another. The backlight drive unit 29 drives the backlight 30 based on the backlight control signal supplied from the control unit 40. The backlight 30 outputs surface-emitted light to the display unit 20. The display drive unit 50 drives the display unit 20 based on the video signal S supplied from the control unit 40. The display unit performs display by modulating light output from the backlight 30. The barrier drive unit 9 drives the liquid crystal barrier 10 according to the barrier control command supplied from the control unit 40. The liquid crystal barrier 10 transmits or blocks the light output from the backlight 30 and transmitted through the display unit 20.

### (Detailed Operation of Stereoscopic View Display)

Next, a detailed operation when the stereoscopic view display is performed will be explained with reference to several drawings.

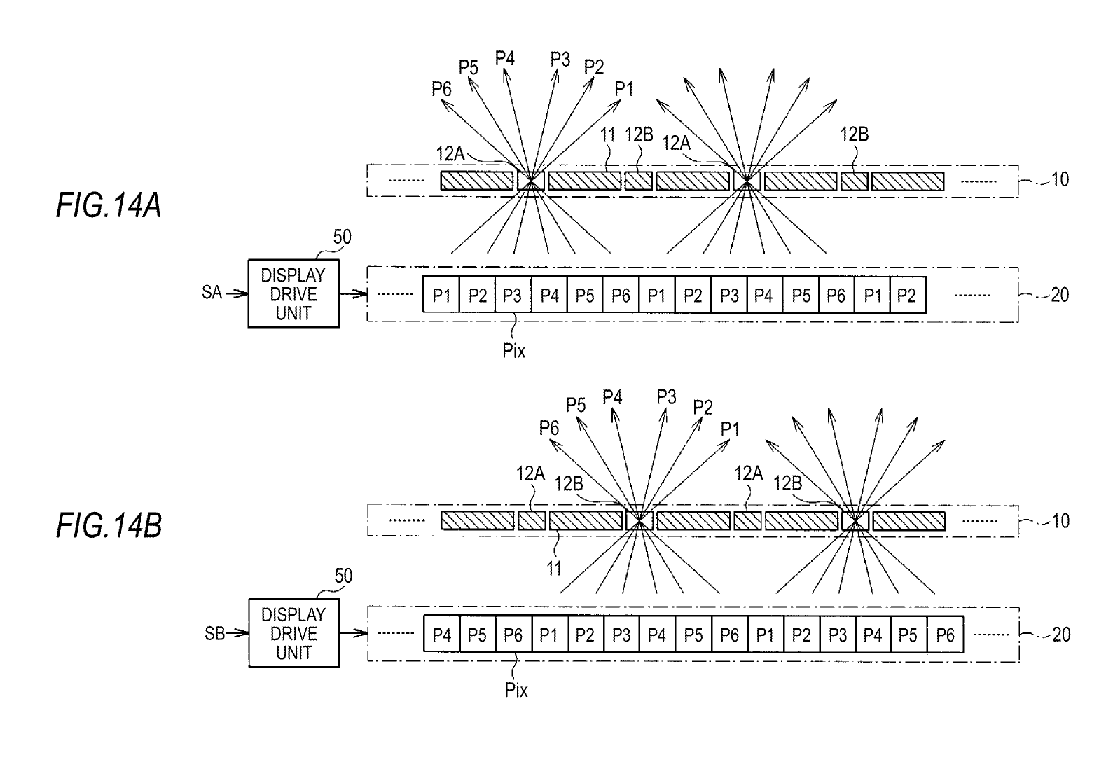

FIGS. 14A and 14B show operation examples of the display unit 20 and the liquid crystal barrier 10, and FIG. 14A shows the case where the video signal SA is supplied and FIG. 14B shows the case where the video signal SB is supplied.

As shown in FIG. 14A, when the video signal SA is supplied, the display drive unit 50 displays pixel information P1 to P6 for six pixels respectively corresponding to the six viewpoint videos contained in the video signal SA on the six pixels Pix adjacent to each other in the display unit 20. The six pixels that display the pixel information P1 to P6 are pixels adjacently arranged near the opening and closing parts 12A. On the other hand, in the liquid crystal barrier 10, as described above, the opening and closing parts 12A are controlled to be in the opening state (transmission state) and the opening and closing parts 12B are controlled to be in the closing state (the opening and closing parts 11 are in the closing state). Thereby, the output angles of the lights output from the respective pixels Pix of the display unit 20 are limited by the opening and closing parts 12A. That is, the six viewpoint videos space-divisionally displayed in the display unit 20 are separated by the opening and closing parts 12A. Of the viewpoint videos separated in this manner, for example, video light based on the pixel information P3 is observed in the left eye of the observer and video light based on the pixel information P4 is observed in the right eye of the observer, respectively, and thereby, they are recognized as a stereoscopic video by the observer.

Similarly, when the video signal SB is supplied, as shown in FIG. 14B, pixel information P1 to P6 for six pixels respectively corresponding to the six viewpoint videos contained in the video signal SB on the six pixels Pix adjacent to each other are displayed in the display unit 20. The six pixels that display the pixel information P1 to P6 are pixels adjacently arranged near the opening and closing parts 12B. On the other hand, in the liquid crystal barrier 10, as described above, the opening and closing parts 12B are controlled to be in the opening state (transmission state) and the opening and closing parts 12A are controlled to be in the closing state (the opening and closing parts 11 are in the closing state). Thereby, the output angles of the lights output from the respective pixels Pix of the display unit 20 are limited by the opening and closing parts 12B. That is, the six viewpoint videos space-divisionally displayed in the display unit 20 are separated by the opening and closing parts 12B. Of the viewpoint videos separated in this manner, for example, video light based on the pixel information P3 is observed in the left eye of the observer and video light based on the pixel information P4 is observed in the right eye of the observer, respectively, and thereby, they are recognized as a stereoscopic video by the observer.

As described above, the observer views different pixel information of the pixel information P1 to P6 with the left eye and the right eye, and the observer may feel it as a stereoscopic video. Further, videos are displayed by time-divisionally and alternately opening the opening and closing parts 12A and the opening and closing parts 12B, and thereby, the observer views the videos displayed in positions shifted from each other in an averaged fashion. Accordingly, the stereoscopic display apparatus 1 can realize resolution twice the resolution when the plural opening and closing parts 12 are not divided into groups but driven in a lump. In other words, the necessary resolution of the stereoscopic display apparatus 1 is ⅓(=⅙×2) compared to the case of the two-dimensional display.

In the above described display unit 20 and liquid crystal barrier 10, the liquid crystal is used, and thus, light is modulated using predetermined polarization components.

### COMPARATIVE EXAMPLE

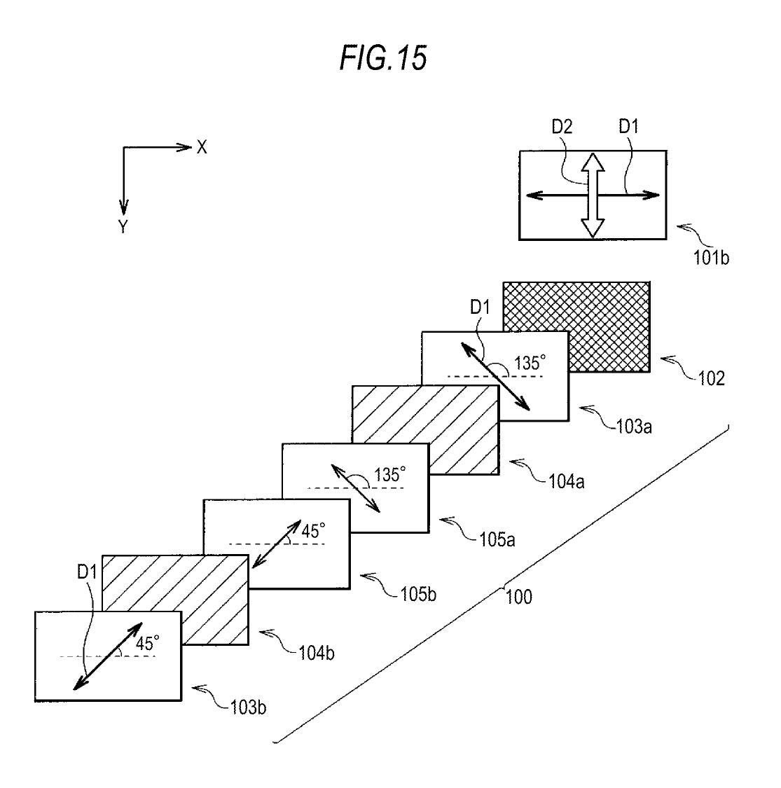

FIG. 15 schematically shows arrangement relationships between polarizing plates and liquid crystal orientation control directions of a stereoscopic display apparatus according to a comparative example of the embodiment. In the comparative example, as is the case of the embodiment, stereoscopic view display is performed by separating the respective viewpoint videos displayed in the display unit by a liquid crystal barrier 100 using TN liquid crystal and showing them to the observer. In the liquid crystal barrier 100 according to the comparative example, a λ/2 plate 102, an incident-side polarizing plate 103a, a WV film 104a, a transparent substrate, a transparent electrode, an orientation film 105a, a liquid crystal layer (TN liquid crystal), an orientation film 105b, a transparent electrode, a transparent substrate, a WV film 104b, and an exit-side polarizing plate 103b are provided sequentially from the display unit side (their illustration is partially omitted).

In the comparative example, as shown in FIG. 15, the orientation directions in the orientation films 105a, 105b in the liquid crystal barrier 100 are along directions rotated to 135°, 45° from the horizontal direction. That is, the incident polarized light to the liquid crystal layer in the comparative example is polarized light rotated to 45°, for example, from the horizontal direction. On the other hand, when the display unit uses liquid crystal in the VA mode (or the IPS mode), for example, the absorption axis D1 of the exit-side polarizing plate 101b in the display unit is aligned with the horizontal direction X (the transmission axis D2 is aligned with the vertical direction Y). Therefore, in the comparative example, the output polarized light from the display unit and the incident polarized light to the liquid crystal layer of the liquid crystal barrier 100 are different from each other. Accordingly, an optical member (here, the λ/2 plate 102) for rotating the polarization direction is provided between the display unit and the liquid crystal barrier 100. Thereby, the light output from the display unit may be allowed to enter the liquid crystal layer in the liquid crystal barrier 100. Note that the light entering the liquid crystal layer without loss is output with its polarization direction rotated to 90° and transmitted through the exit-side polarizing plate 103b having the absorption axis D1 in the direction at 45°, for example. Therefore, the polarization direction of the light finally reaching the observer is a direction rotated to 135° from the horizontal direction, for example.

However, in the stereoscopic display apparatus using the liquid crystal barrier 100 as in the comparative example, it is necessary to insert the λ/2 plate between the display unit and the liquid crystal barrier 100 as described above. Accordingly, the number of parts increases and the cost rises.

On this account, in the embodiment, the respective orientation control directions (rubbing directions) of the orientation films 16a, 16b in the liquid crystal barrier 10 are orthogonal to each other, and the orientation direction at the display unit 20 side of the liquid crystal 14 (here, the orientation direction in response to the orientation film 16a) is in parallel or orthogonal to the absorption axis direction of the polarizing plate 206b. For example, as shown in FIG. 10, in the orientation films 16a, 16b, rubbing treatment is performed along the horizontal direction X or the vertical direction Y. Further, the polarizing plate 206b in the display unit 20 also serves as the incident-side polarizing plate in the liquid crystal barrier 10, and the respective polarization directions of the polarized light output from the display unit 20 and the polarized light incident to the liquid crystal layer 14 are aligned with the vertical direction Y, for example. That is, the light output from the display unit 20 enters the liquid crystal layer 14 of the liquid crystal barrier 10 with its polarization direction kept. Therefore, the λ/2 plate 102 as in the comparative example is not necessary, and the increase in the number of parts and the cost by that may be suppressed.

Further, since the orientation direction at the display unit side of the liquid crystal layer 14 is set in response to the absorption axis of the polarizing plate 206b, both the polarizing plate at the exit side (the liquid crystal barrier 10 side) in the display unit 20 and the polarizing plate at the incident side (the display unit 20 side) in the liquid crystal barrier 10 may be served by the one polarizing plate 206b. That is, one polarizing plate may be omitted, further reduction of the number of parts and the cost may be realized, and the reduction of the light transmittance by the insertion of the polarizing plate may be suppressed.

Furthermore, since the display unit 20 and the liquid crystal barrier 10 are bonded (optically bonded), compared to the case with an air layer in between, light loss maybe reduced and the light use efficiency may be increased.

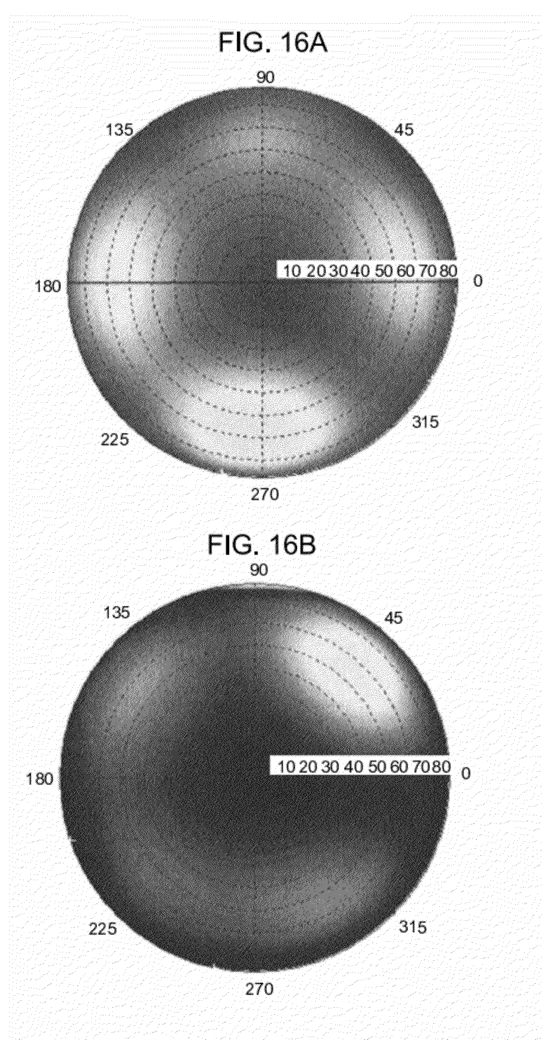

In addition, since the respective orientation directions at the light incident side and the light exit side in the liquid crystal layer 14, for example, the respective orientation control directions in the orientation films 16a, 16b are aligned with the horizontal direction X and the vertical direction Y, it is not necessary to use a polarizing plate having an absorption axis in the direction at 45° (135°). Thereby, for example, the viewing angle in the horizontal direction at black representation becomes wider. Here, FIGS. 16A and 16B show viewing angle characteristics in the comparative example and the respective examples of the embodiment. The charts show that, as the black density is darker, black may be represented more faithfully. It is known that, in the comparative example using the polarizing plate having the absorption axis in the direction at 45° (135°) (FIG. 16A), the viewing angle in the horizontal direction becomes narrower, and, on the other hand, in the embodiment using the polarizing plate having the absorption axis in the horizontal and vertical (0°, 90°) directions (FIG. 16B), the viewing angle in the horizontal direction becomes wider. As described above, in the embodiment, according to the arrangement configuration of the absorption axes of the polarizing plates and the liquid crystal orientation control directions in the liquid crystal barrier 10, the viewing angle characteristics in the horizontal direction may be improved in the displayed videos. This advantage is particularly effective at stereoscopic view display of separating images to right and left.

As described above, in the embodiment, the display unit 20 space-divisionally displays plural viewpoint videos and the displayed videos are transmitted or blocked in the plural opening and closing parts 11, 12 of the liquid crystal barrier 10. Thereby, for example, in the right and left eyes of the observer, respectively corresponding viewpoint images are visually recognized, and stereoscopic view display is performed. In this regard, in the liquid crystal barrier 10, the liquid crystal layer 14 is orientation-controlled in directions orthogonal to each other at the light incident side and the light exit side, and the orientation direction at the display unit 20 side of the liquid crystal layer 14 (the orientation direction in response to the orientation film 16a) and the absorption axis direction of the polarizing plate at the liquid crystal barrier 10 (the polarizing plate 206b) of the display unit 20 are in parallel or orthogonal to each other. Thereby, the light output from the display unit 20 may be allowed to enter the liquid crystal layer 14 of the liquid crystal barrier 10 without rotation of the polarization direction (polarization axis). That is, it is not necessary to separately provide an optical member for rotation of the polarization direction, e.g., a λ/2 plate or the like. Thus, stereoscopic view display of parallax barrier system using a liquid crystal barrier can be realized without increase in the number of parts and the cost.

Next, stereoscopic display apparatuses according to modified examples (modified examples 1, 2) of the embodiment will be explained. In modified examples 1, 2, the polarization axes of the respective polarizing plates and the liquid crystal orientation control directions are different from those of the embodiment. The other respective component elements are the same as those of the stereoscopic display apparatus 1 that has been explained in the embodiment. The same signs are assigned to the same component elements as those of the embodiment, and their explanation will be appropriately omitted.

### MODIFIED EXAMPLE 1

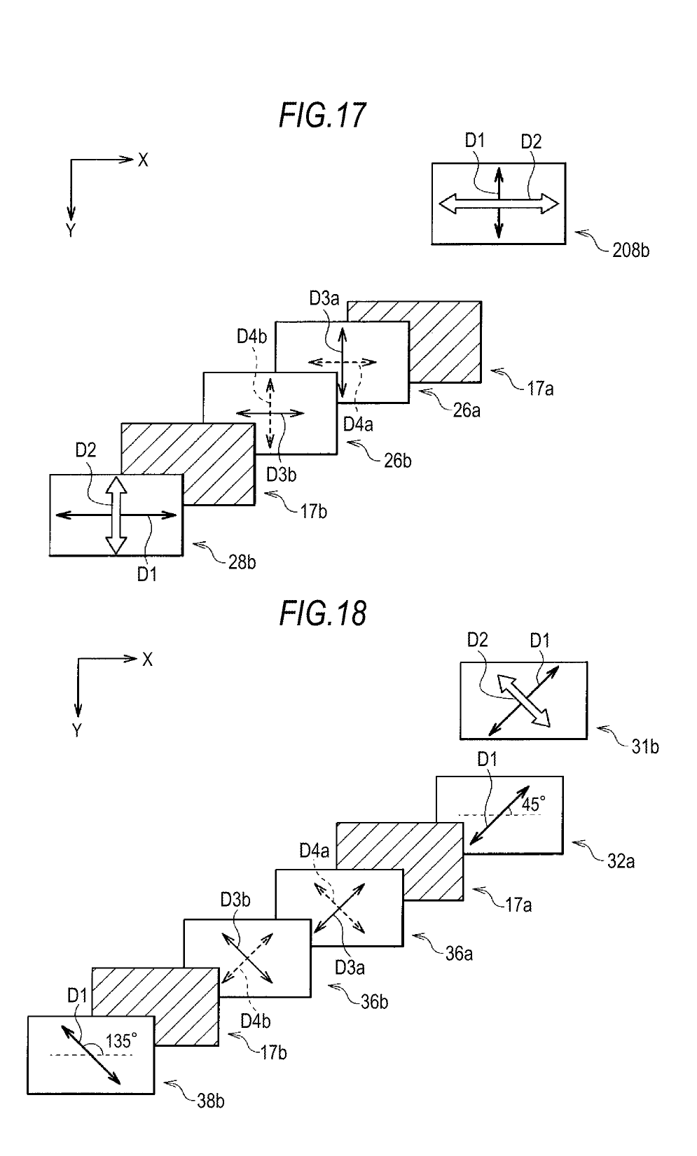

FIG. 17 shows relationships between polarization axes of respective polarizing plates and liquid crystal orientation control directions in modified example 1. In this modified example, like the embodiment, the liquid crystal barrier has the liquid crystal layer 14 including TN liquid crystal, and the orientation direction at the display unit 20 side of the liquid crystal layer 14 and the absorption axis direction of the exit-side polarizing plate (first polarizing plate) in the display unit 20 are in parallel or orthogonal to each other. Note that, in the modified example, the polarization direction of the light output from the display unit 20 is aligned with the horizontal direction X. That is, the absorption axis D1 of a polarizing plate 208b is equal to the vertical direction Y (the transmission axis D2 is equal to the horizontal direction X).

Also, in this case, the respective rubbing directions in orientation films 26a, 26b for orientation control of the liquid crystal layer 14 are equal to the horizontal direction X or the vertical direction Y. Specifically, in the orientation films 26a, 26b, the directions are one of a combination of directions D3a, D3b (solid-line arrows) or a combination of directions D4a, D4b (broken-line arrows). One of the combinations may be appropriately set depending on the mode (O-mode, E-mode) of the liquid crystal molecules in the liquid crystal layer 14 as described above. For example, the directions may be set to the directions D4a, D4b in the case of the O-mode, and may be set to the directions D3a, D3b in the case of the E-mode. In either case, when the TN liquid crystal is used for the liquid crystal layer 14, the absorption axis D1 in an exit-side polarizing plate 28b in the liquid crystal barrier is aligned with the horizontal direction X (the transmission axis is aligned with the vertical direction Y).

As described above, in the modified example, the absorption axes of the polarizing plate 208b and the exit-side polarizing plate 28b are set so that the output polarized light from the display unit 20 and the incident polarized light to the liquid crystal layer 14 of the liquid crystal barrier 10 may be aligned, and the orientation control directions in the liquid crystal layer 14 are set in response thereto. Therefore, also, in the modified example, the same advantages as those of the embodiment may be obtained. Further, the polarization direction of the light output from the liquid crystal barrier is equal to the vertical direction Y, and thus, even in the case of observation using polarization sunglasses or the like, for example, stereoscopic view display can be performed.

### MODIFIED EXAMPLE 2

FIG. 18 shows relationships between polarization axes of respective polarizing plates and liquid crystal orientation control directions in modified example 2. In this modified example, like the embodiment, the liquid crystal barrier has the liquid crystal layer 14 including TN liquid crystal, and the orientation direction at the display unit 20 side of the liquid crystal layer 14 and the absorption axis direction of the exit-side polarizing plate (first polarizing plate) in the display unit 20 are in parallel or orthogonal to each other. Note that, in the modified example, the drive mode of the liquid crystal in the display unit 20 is the TN mode, and the absorption axis D1 of an exit-side polarizing plate 31b in the display unit 20 is aligned with a direction at 45°.

In this case, the respective rubbing directions in orientation films 36a, 36b for orientation control of the liquid crystal layer 14 are equal to the direction at 45° or the direction at 135°. Specifically, in the orientation films 36a, 36b, the directions are one of a combination of directions D3a, D3b (solid-line arrows) or a combination of directions D4a, D4b (broken-line arrows). One of the combinations may be appropriately set depending on the mode (O-mode, E-mode) of the liquid crystal molecule in the liquid crystal layer 14 as described above. In either case, when the TN liquid crystal is used for the liquid crystal layer 14, the absorption axis D1 in an exit-side polarizing plate 38a in the liquid crystal barrier is aligned with the direction at 135°. Note that, in the liquid crystal barrier of the modified example, an incident-side polarizing plate 32a is provided at the display unit 20 side. That is, the respective absorption axes of the exit-side polarizing plate 31b in the display unit 20 and the incident-side polarizing plate 32a in the liquid crystal barrier are aligned with each other and the polarizing plates are bonded. Note that, in the case where the respective absorption axes of the exit-side polarizing plate 31b and the incident-side polarizing plate 32a are aligned, also, in the modified example, as is the case of the embodiment, the incident-side polarizing plate 32a can be omitted and only one polarizing plate may be provided between the display unit 20 and the liquid crystal barrier.

As described above, in the modified example, the absorption axes of the incident-side polarizing plate 32a and the exit-side polarizing plate 38b are set so that the output polarized light from the display unit 20 and the incident polarized light to the liquid crystal layer 14 of the liquid crystal barrier 10 may be aligned, and the orientation control directions in the liquid crystal layer 14 are set in response thereto. Therefore, even in the case where the liquid crystal in the TN mode is used in the display unit 20, nearly the same advantages as those of the embodiment may be obtained.

The present disclosure has been explained by citing the embodiment and the modified examples, however, the present disclosure is not limited to the embodiment and the like, but various modifications may be made. For example, in the embodiment and the like, the display unit 20 and the liquid crystal barrier 10 have been sequentially arranged from the side of the backlight 30, however, the arrangement relationship between the display unit 20 and the liquid crystal barrier 10 may be reversed thereto. That is, the liquid crystal barrier 10 may be provided between the backlight 30 and the display unit 20. Even in this case, by performing opening and closing operations in the liquid crystal barrier 10 in synchronization with the above described video display in the display unit 20, stereoscopic view display may be realized. Further, according to the configuration in which the orientation direction at the display unit 20 side (light exit side) of the liquid crystal layer 14 and the absorption axis direction of the incident-side polarizing plate (first polarizing plate) of the display unit 20 are in parallel or orthogonal to each other, the same advantages as those of the present disclosure may be obtained.

Further, in the embodiment and the like, at stereoscopic view display, in the plural opening and closing parts 11, 12 of the liquid crystal barrier 10, the opening and closing parts 11 have been driven to be maintained in the closing state and the opening and closing parts 12 have been driven to be turned into the opening state based on the video signals, however, reversed driving thereto (the opening and closing parts 12 are maintained in the closing state and the opening and closing parts 11 are turned into the opening state) may be performed.

Furthermore, in the embodiment and the like, in order to obtain high resolution, of the opening and closing parts 11, 12, the opening and closing parts 12 have been further divided into two groups A, B and the groups A, B have been time-divisionally driven, however, the video display by the time-divisional driving is not necessarily required for the present disclosure. That is, viewpoint videos may be separated by driving all of the opening and closing parts 11 in the liquid crystal barrier 10 to be closed and all of the opening and closing parts 12 to be opened. Or, the number of groups of the opening and closing parts 12 maybe three or more, and the three or more groups may be sequentially driven.

In addition, in the embodiment and the like, the polarizing plate at the exit side (the liquid crystal barrier 10 side) in the display unit 20 has also served as the polarizing plate at the incident side (the display unit 20 side) in the liquid crystal barrier 10, however, the two polarizing plates may be respectively provided. That is, the exit-side polarizing plate of the display unit 20 and the incident-side polarizing plate of the liquid crystal barrier 10 may be bonded. Even in the case, it is not necessary to provide an optical member of a λ/2 plate or the like between the display unit and the liquid crystal barrier, and the equivalent advantages as those of the present disclosure may be obtained.

Further, in the embodiment and the like, the WV film has been used as a viewing angle compensation film in the liquid crystal barrier, however, another viewing angle compensation film may be used, or the viewing angle compensation film may not necessarily be provided.

Furthermore, in the embodiment and the like, the video signals SA, SB have contained six viewpoint images, however, not limited to that, the signals may contain five or less or seven or more viewpoint images. For example, in the case where the video signal contain five viewpoint images, the opening and closing parts 12 may be provided at a ratio of five pixels Pix of the display unit 20 to one. Note that the number of viewpoint videos and the number of pixels for display of them may not necessarily be the same. That is, for example, pixel information displayed on adjacent four pixels Pix may not necessarily be on different viewpoints, but may contain videos of the same viewpoints. Or, plural viewpoint videos may contain blank (black or gray) videos.

The present disclosure contains subject matter related to that disclosed in Japanese Priority Patent Application JP 2010-179556 filed in the Japan Patent Office on Aug. 10, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display unit having a pair of polarizing plates at a light incident side and a light exit side; and
a light barrier unit that is provided at the light incident side or the light exit side of the display unit and includes plural opening and closing parts as light transmission regions or light blocking regions,
wherein the light barrier unit has a liquid crystal layer orientation-controlled at a light incident side and a light exit side thereof in directions orthogonal to each other, and
an orientation direction at the display unit side of the liquid crystal layer is in parallel or orthogonal to an absorption axis direction of a first polarizing plate of the pair of polarizing plates provided at the light barrier unit side of the display unit.

2. The display apparatus according to claim 1, wherein a second polarizing plate that controls incident polarized light to the liquid crystal layer or output polarized light from the liquid crystal is provided between the first polarizing plate and the liquid crystal barrier, and an absorption axis direction of the second polarizing plate is aligned with the absorption axis direction of the first polarizing plate.

3. The display apparatus according to claim 1, wherein the display unit and the light barrier unit are bonded.

4. The display apparatus according to claim 1, wherein the light barrier unit has:
a pair of substrates that sandwich the liquid crystal layer;
first and second electrodes respectively provided at the liquid crystal layer side of the pair of substrates;
a first orientation film that is provided on the first electrode and controls the liquid crystal layer in a first orientation direction; and
a second orientation film that is provided on the second electrode and controls the liquid crystal layer in a second direction orthogonal to the first orientation direction.

5. The display apparatus according to claim 4, wherein the orientation control is performed respectively on the first and second orientation films by rubbing treatment.

6. The display apparatus according to claim 4, wherein at least one of the first and second electrodes includes plural sub-electrodes that can individually supply voltages, and
regions corresponding to the respective plural sub-electrodes are the opening and closing parts.

7. The display apparatus according to claim 4, wherein the liquid crystal layer in the light barrier unit is driven in a TN mode.

8. The display apparatus according to claim 7, wherein the display unit includes a liquid crystal layer driven in a VA mode or an IPS mode, and
the absorption axis direction of the first polarizing plate is a horizontal direction or a vertical direction.

9. The display apparatus according to claim 7, wherein the display unit includes a liquid crystal layer driven in a TN mode, and
the absorption axis directions of the first polarizing plate are two directions respectively rotated to 45° from the respective directions of a horizontal direction or a vertical direction.

10. A display apparatus comprising:
a display unit;
a light barrier unit provided to be opposed to the display unit; and
a polarizing plate provided between the display unit and the light barrier unit,
wherein the light barrier unit has a liquid crystal layer, and
an orientation direction at the display unit side of the liquid crystal layer is in parallel or orthogonal to an absorption axis direction of the polarizing plate.

11. A light barrier device comprising:
plural opening and closing parts as light transmission regions or light blocking regions; and
a liquid crystal layer respectively orientation-controlled in a nearly horizontal direction at one of a light incident side and a light exit side thereof and in a nearly vertical direction at the other.
